(19) United States
(12) Patent Application Publication
(10) Pub. No.: US 2009/0265604 A1
(43) Pub. Date: Oct. 22, 2009

(54) GRAPHICAL REPRESENTATION OF SOCIAL NETWORK VITALITY

(75) Inventors: Joshua Howard, Redmond, WA (US); Bryan Trussel, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/106,610

(22) Filed: Apr. 21, 2008

(51) Int. Cl. G06F 15/16; G06F 17/00

(52) U.S. Cl. 715/205; 709/204

(57) ABSTRACT

A method for presenting a graphical representation of the strength or vitality of a contact's social network is disclosed. When a user pulls up a graphical user interface displaying contacts in his or her social network, in addition to the traditional profile data for each contact, a virtual object may be displayed. The virtual object for a contact may be displayed in different ways, depending on the strength of the contact's social network. Thus, a user may access a contact in their social network and, by viewing the social network virtual object, quickly and easily get a sense of the strength and vitality of that contact's social network.

### BACKGROUND

Social networking via the Internet is emerging as a popular method of expanding and developing social and business relationships. A social network has been defined as a map of the relationships between individuals, showing how they are connected through various social ties ranging from casual acquaintance to close bonds. The term social network has also been used to refer to the network infrastructure for bringing people together and simplifying the way in which relationships may be mapped and developed. The idea behind social networking is that people can leverage their friends and acquaintances to meet other people of interest.

Social networks have been known in one form or another for thousands of years. However, with advent and proliferation of the Internet, large enterprise service providers, such as MSN®, Yahoo® and AOL® service providers, allow individuals access to a tremendous network of contacts, organized in a coherent structure and easily accessible with a network connection. Aside from size, organization and ease of access, another benefit to Internet social networks is the trust and reliability of the people within one's network. Even if a person does not know a friend of a friend, there is at least an inference of trust and reliability in that the first person can assume that his or her friend would not associate with a friend who was not reliable or trustworthy. At least, the immediate friend can be trusted to offer an honest assessment of the trustworthiness of the third party. Social networks are also often relied upon for opinion based information such as for example, movies, restaurants, travel locations and the like.

Aside from the content within a user's social network, the size of the user's social network itself may provide information and be a source of pride for the user. For example, Linkedin® online business networking services has a statement on each user's homepage of how many connections that user has. Other users can view that page, and those having large numbers of connections are typically seen as influential social hubs and a worthwhile connection to have. Aside from an actual statement as to how many people a user has in their social network, the inventors are unaware of other methods for indicating the strength or vitality of a social network.

### SUMMARY

The present system, roughly described, relates to a method for presenting a graphical and/or functional representation of the strength or vitality of a contact's social network. When a user pulls up a graphical user interface displaying contacts in his or her social network, in addition to the traditional profile data for each contact, a virtual object may be displayed. The virtual object for a contact may be displayed in different ways, depending on the strength of the contact's social network. In particular, as the strength and vitality of the contact's social network improves, attributes may be added to his or her associated virtual object, or the virtual object may otherwise change, making the object nicer and more impressive than the virtual object for another contact whose social network is less vital. Thus, a user may access a contact in their social network and, by viewing the social network virtual object, quickly and easily get a sense of the strength and vitality of that contact's social network.

The social network virtual object may be any of various graphical items, including but not limited to an automobile or boat, a house or other building, a person or a garden. In accordance with the present system, regardless of what the graphical item is, the appearance and, optionally, the corresponding functionality, of the item will be based on the strength of the displayed contact's social network, and will change as the displayed contact's social network becomes stronger or weaker.

The determination and rendering of the composition of the virtual object is performed by a social network virtual object engine. In general, objective measurement criteria for the strength of a user's social network may be developed and applied by the social network virtual object engine. For example, the strength of a contact's social network may be based solely on the number of people in that contact's social network. The strength of that contact's social network may additionally or alternatively depend on the frequency with which the contact corresponds with the people in his/her social network. Other criteria such as the quality, variety and/or characteristics of members of the social network are possible. Using these criteria, as the strength of a user's social network increases, the virtual object engine may cause attributes to be added to the displayed social network virtual object, making the displayed object nicer and more impressive.

### BRIEF DESCRIPTION OF THE DRAWINGS

FIG. 1 is a block diagram of a system implementing one embodiment of the present system.

FIG. 2 is an illustrative window presented on a graphical user interface showing a page from a user's social network.

FIGS. 3-6 are representations of different levels of virtual objects used to represent the strength of a contact's social network in an embodiment of the present system.

FIGS. 7-9 are representations of different levels of virtual objects used to represent the strength of a contact's social network in an alternative embodiment of the present system.

FIG. 10 is a block diagram of computer hardware suitable for implementing embodiments of the present system.

### DETAILED DESCRIPTION

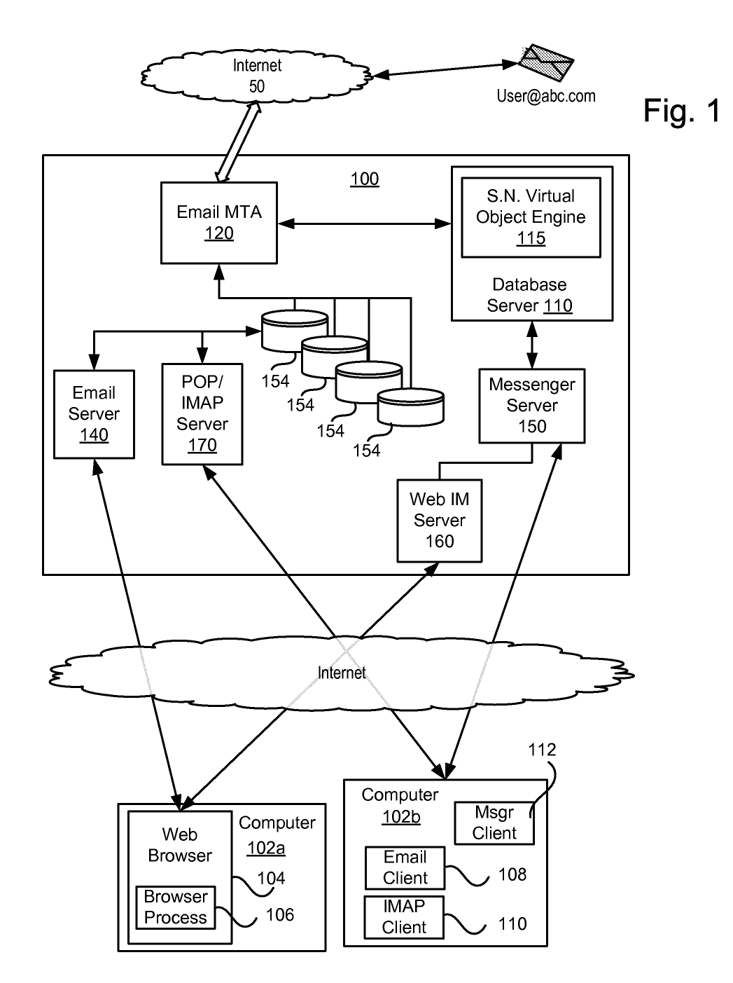

Embodiments of the present system will now be described with reference to FIGS. 1-10 which in general relate to a method of providing a graphical indication of the vitality of a user's social network. In addition, the present system encourages growth of social networks by building games and contests around enhancing one's graphical indicator.

A social network according to the present system may be implemented as part of a database for storing contact and other profile information on, for example, an enterprise service provider, such as MSN®, Yahoo®, AOL®, or other online service providers. It is understood that the database supporting the profile information of the present system may be stored on servers and processing devices other than for enterprise service providers in alternative embodiments.

FIG. 1 is a block diagram illustrating an embodiment of a service provider system 100 for implementing a social network. The service provider system 100 may be operated by an enterprise service provider such as MSN®, Yahoo®, AOL®, or other online service providers. The service provider system 100 may support different application interfaces allowing networked communication. For example, where service provider system 100 is that of the MSN® network, the system 100 may support a social networking application such as Windows Live Spaces, an email application program such as MSN Hotmail® and/or an instant messaging application program such as MSN Messenger. Other application interfaces are contemplated. Service provider system 100 may alternatively or additionally support networked gaming, as in an example where the service provider system is Live® online game service. FIG. 1 may be modified to include clients for each of these application interfaces.

System 100 is comprised of a plurality of computing devices maintained by an enterprise service provider. In one embodiment, it may consist, for example, of a message transfer agent (MTA) 120, a user information database server 110, user mail storage units 154, an email server 140, a POP/IMAP server 170, a messaging server 150 and a web integrated messaging server 160. System 100 allows users operating processing devices 102a and 102b to access user profiles, contact lists, email, messenger, and other data, and forward outbound messages and messaging information to users within the domain of system 100 and domains accessible via the Internet 50. Users may connect to the system 100 via any number of public or private networks including the Internet.

The user database server 110 stores information allowing users to authenticate themselves to system 100 to access the service provider services. The database server 110 may also store user profile information and a list of contacts forming the user's social network. The database server 110 further allows other servers in the system to direct mail and messages within the system to storage locations on storage units 154.

Email server 140 may comprise a web server which provides an email interface to a web browser 108 which institutes a browser process 106 on the user computer 102a. Email server 140 can render email data from the data storage units 154 to a user using processing device 102a to access the system 100. Likewise POP/IMAP server 170 can provide email data to a POP e-mail client 118 or an IMAP client 110 on user computer 102b. Messenger server 150 can provide information directly to a messenger client 112 or via a web Internet messaging server 160 to web based messenger clients operating in a browser process 106 and web browser 104.

Inbound and outbound email messages from users on computers 102a and 102b are sent and received in system 100 via the MTA 120. Email MTA 120 generally uses SMTP to route mail via the Internet 50 to users at other Internet accessible domains. E-mail MTA 120 is a front-end server to which emails 190 transmitted via the Internet to system 100 are directed and which forward messages from users of the messaging system 100 to other users on the Internet 50. It should be understood that on a web based enterprise service provider environment, a number of email MTAs 120 will be present.

The user database server 110 is a data store of user account and profile information for each of the users having a user account or email address within system 100. As explained hereinafter, database server 110 may further include a social network virtual object engine 115 for measuring the strength of a user's social network, and building a graphical representation of that strength for display.

Storage units 154 may essentially be large disk arrays storing user message information. The system may include additional components not shown in FIG. 1 for convenience in understanding the present system.

With the above service provider system 100, a stored contact from a social network may be accessible from and available to a user over any of a variety of application interfaces, such as for example an instant messaging application program, an email application program, a blog application program and/or in a friends list of a gaming program. A user may add a new contact to his or her social network when in one of the above-named application interfaces, or elsewhere, as is known in the art. In particular, when in an application program allowing the addition of a new contact, upon selecting the proper option as from a tool bar or drop down menu, the user may be presented with a window over the user's graphical user interface prompting the user to add profile information about the new contact. Such profile information may include name, address, company, telephone numbers, email addresses, website, the contact's screen name, etc.

Once a user adds a contact to his or her social network, a notification, or invitation, may be sent to the contact to determine whether the contact has added or would like to add that user to his or her contacts. If the invitation is accepted, there is said to be a two-way link, or a mutual friendship, between the contact and user, and each is part of the other's social network. If the contact declines the invitation to add the user to the contact's social network, there is said to be a one-way link between the user and the contact, and the user may be referred to as a fan of the contact.

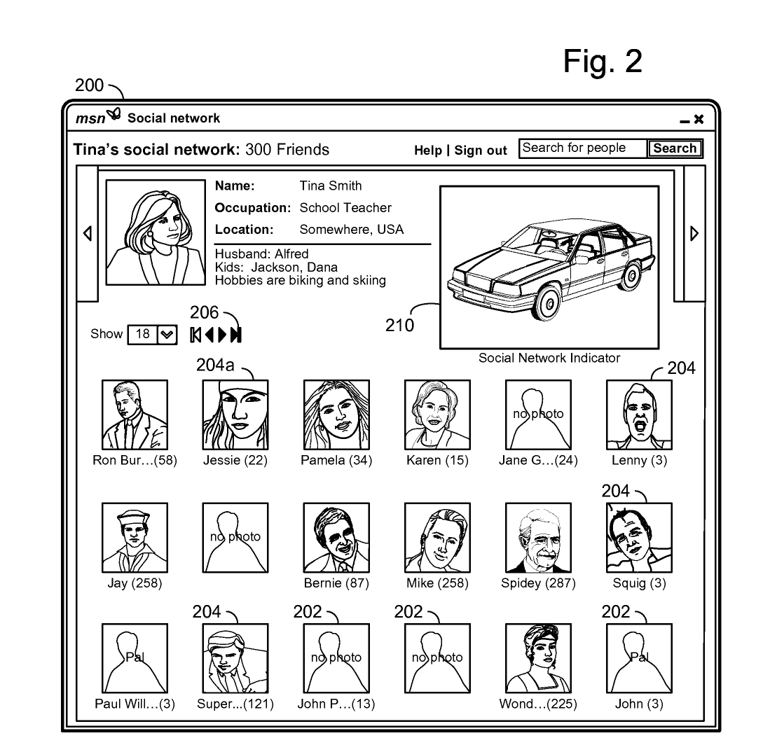

As shown in FIG. 2, a user may pull up a graphical user interface window showing the social network for a variety of stored contacts within his or her social network. It is understood that the graphical user interface of FIG. 2 is one of many possible layouts over which a user may access and/or view his or her social network. In the event there is a two-way link between a user and a particular stored contact, the particular stored contact may appear on the user's social network with a graphical image, which may be a picture of the contact, or some other graphical representation selected by the contact. Where no graphical image is supplied by the contact, or there exists only a one-way link, predetermined images may be used.

FIG. 2 shows a graphical user interface, or page, 200 from a user's social network presented on a display of a computing device 102a or 102b. The page 200 may be presented in response to a request made by a user on database server 110 via a browser running on the user's computing device. In particular, the user may have a list of stored contacts that comprise his or her social network. When the user accesses a contact, the user may be shown profile information for that contact, as well as that contact's social network.

By way of example only, the user may access a contact “Tina Smith.” The social network page 200 shows profile information for Tina, such as name, address, telephone, email, etc., as well as Tina's contacts in her social network. Of the contacts of Tina's shown, some of them are shown in silhouette only, such as as contacts 202, indicating that these contacts have not accepted a two-way link with Tina. Other contacts, such as contacts 204, have graphical images such photographs or other representations indicating a mutual friendship between Tina and those contacts 204. Tina may be viewed as the owner of the stored contacts in her social network which are displayed on page 200, as distinguished from the user who is viewing the contacts but did not create them.

Additional stored contacts for Tina may be viewed by clicking (with a graphical pointer under the control of a mouse or other pointing device as is known in the art) on navigation buttons 206 to show the next page of contacts in Tina's social network of stored contacts. Additionally, the contacts 204 may be live hyperlinks so that when one is clicked, the database server 110 provides the social network contacts of the selected contact 204. For example, if the user were to click on the contact 204a (screen name “Jessie”), the user may be presented with a page similar to page 200 but showing Jessie's social network contacts, as well as a virtual object 210 for Jessie, explained below. In turn, a mutual friend shown on Jessie's contacts may be clicked on to access that person's social network contacts and virtual object 210, and so on.

In accordance with the present system, a portion of the page 200 may be set aside for displaying a social network virtual object 210, which is a graphical representation of the strength or vitality of the displayed contact's social network. The social network virtual object 210 is shown toward the upper right of the page 200, but it is understood that the social network virtual object 210 may be displayed anywhere on the page 200. As explained below, the social network virtual object 210 may be any of various graphical items, including but not limited to an automobile or boat, a house or other building, a person or a garden. In accordance with the present system, regardless of what the graphical item is, the appearance of the item will be based on the strength of the displayed contact's social network, and will change as the displayed contact's social network becomes stronger or weaker. The determination and rendering of the composition of the virtual object 210 is performed by the social network virtual object engine 115 as explained below.

It is a feature of the present system that a user may access a contact in their social network and, by viewing the social network virtual object 210, quickly and easily get a sense of the strength and vitality of that contact's social network. In particular, as the strength and vitality of a contact's social network improves, attributes may be added to his or her associated virtual object 210, or the virtual object 210 may otherwise change, making the indicator nicer and more impressive than the social network virtual object 210 for another contact whose social network is less vital. While “nicer” and “more impressive” are subjective terms, as used herein, those terms refer to what at least most people would consider to be nicer, and what at least most people would consider to be more impressive. A user may also view their own page 200 including their own virtual object 210.

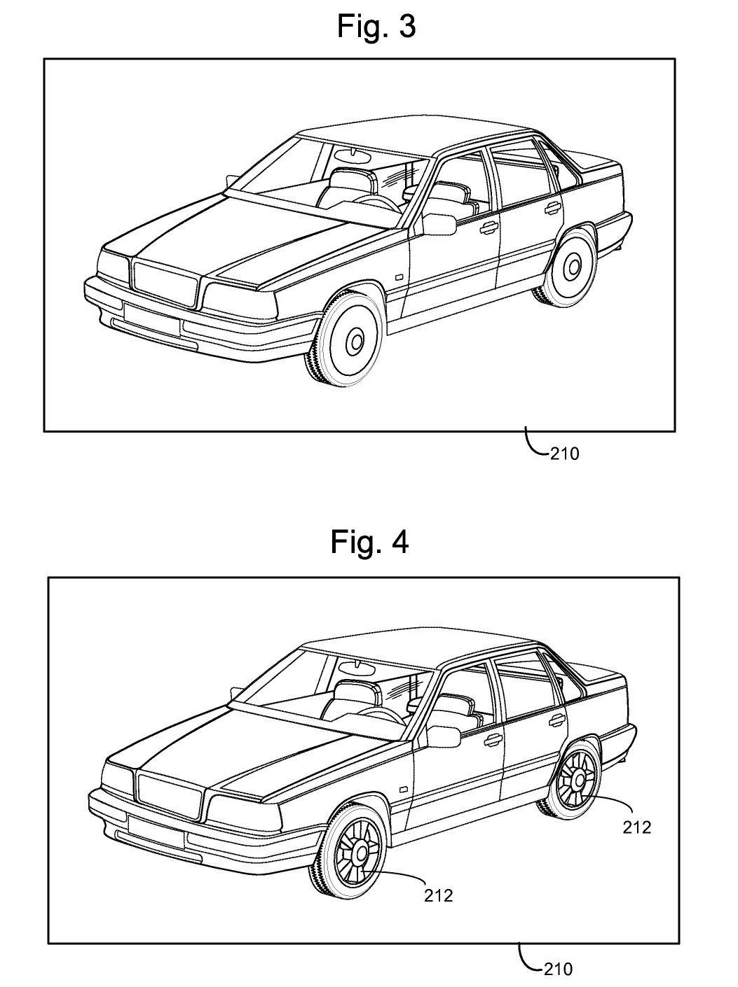

In general, objective measurement criteria for the strength of a contact's social network may be developed and applied by the social network virtual object engine. Using these objective measurement criteria, as the strength of a contact's social network increases, attributes may be added to the displayed social network virtual object 210 making the displayed object nicer and more impressive. These features are explained below in greater detail with reference to FIGS. 3-10.

The object selected for display as the social network virtual object 210 may be a graphical object where distinguishable visible improvements may be added to the object to indicate differences in the strength of a contact's social network. For example, the virtual object may be a car (FIGS. 3-6), where contacts having a comparatively weak social network have a basic version of the car displayed, and contacts having a comparatively strong social network have a version of the car fully decked out with many additional accessories.

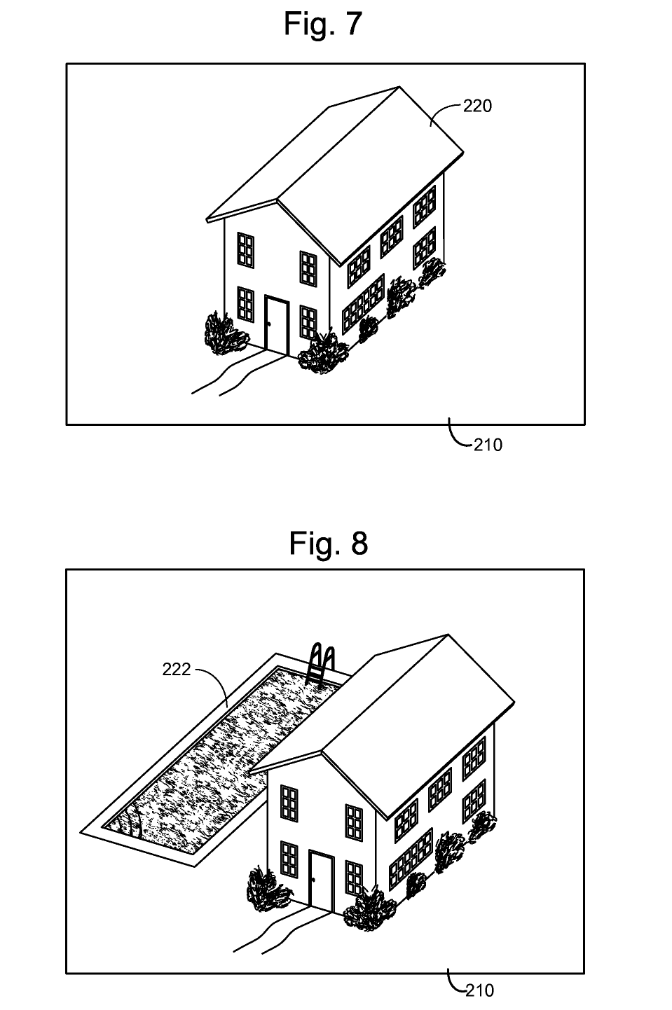

The virtual object may alternatively be a house (FIGS. 7-10), where contacts having a comparatively weak social network have a simple house displayed, while contacts having a comparatively strong social network have a luxurious house displayed. The virtual object may alternatively be a person, where contacts having a comparatively weak social network have the person modestly adorned, while contacts having a comparatively strong social network have a person that is well dressed and/or wearing expensive jewelry. The virtual object may alternatively be a garden, where contacts having a comparatively weak social network have a sparse garden displayed, while contacts having a comparatively strong social network have a beautiful garden displayed. These are a few examples of the many possibilities of the virtual object 210. Virtual object 210 may be any graphical object capable of being displayed and readily understood as having different states which range from simple on the low end to luxurious or impressive on the high end.

The graphical object selected for display as the virtual object 210 may be selected by the service provider, and applied across an entire social network, or some subgroup of the social network. For example, in one embodiment, the service provider may dictate that everyone in the social network will have an automobile as the social network virtual object 210. Alternatively, a first subgroup of the social network may have an automobile as the virtual object 210, while a second subgroup may have a boat, etc. There may be two or more such subgroups. In embodiments, the service provider may assign users to particular subgroups, or users may subscribe to a subgroup of their choosing. Automobile enthusiasts may choose an automobile, boat enthusiasts may choose a boat, etc. Such an embodiment has the advantage that those subscribing to the same virtual object have at least one similar interest.

As indicated above, various objective criteria may be used to measure the strength and vitality of a user's social network. In one embodiment, a straightforward criterion that could be used is simply the number of people within a user's social network. In such an embodiment, a user having between 0 and i users in their social network would be at a first level, between i and j users (j>i) would be a second level, between j and k users (k>j) would be a third level, and between k and m users (m>k) would be a fourth level. There may be two, three or more than four different levels in further embodiments. Each level would have its own unique virtual object 210, with a contact's virtual object 210 getting nicer and more impressive as the contact attains new levels.

It is understood that a variety of other objective criteria may also carry weight in determining the level of a contact's virtual object. For example, the frequency with which a contact corresponds with people in his/her network via the service provider system 100 may weigh into determining the strength of the contact's social network. Alternatively, the length of time a contact spends conversing with social network friends through the service provider system 100 may weigh into determining the strength of the contact's social network. The number of users that have a particular contact within their social network may weigh into determining the strength of that particular contact's social network (this may be different than the number of users that particular contact has in his/her social network, as users may have that contact in their network, where the contact does not have those users in his/her network). Other criteria may be used, and one or more of the above-described criteria may be combined in various weightings, in order to determine the strength of a given contact's social network.

The one or more criteria which factor into the determination of a given contact's social network may be arbitrarily selected by the service provider and recorded by the service provider system 100. The social network virtual object engine 115 may be configured to receive one or more of these measured criteria, and, based on the predetermined weighting of the one or more criteria, the social network virtual object engine 115 may determine and store the overall strength of each contact's social network within the community of stored contacts.

The social network virtual object engine 115 also stores a table associating a particular virtual object 210 with each level. The boundary between different levels may be arbitrarily selected by the service provider and used by the social network virtual object engine 115. Thus, once the strength of a contact's social network is determined by the social network virtual object engine 115, the engine 115 may then use the table to determine which image is displayed as the virtual object 210 for that contact. In embodiments, the same criteria and table are used to determine the virtual object for all contacts in the social network (or in the same subgroup within the social network). Different contacts will thus have different virtual objects, based on the strength of their respective social networks, and the virtual object for a given contact may change when the contact attains a new level.

As one of many possible examples, FIG. 3 shows a virtual object 210 which would be displayed in association with a contact's social network page 200. In the example of FIG. 3, based on the criteria selected by the service provider, it may be determined that the contact is at level one. Accordingly, the virtual object 210 shown in this example is that of a basic automobile.

However, over time, the contact may acquire additional contacts in their social network, converse more frequently with others in their social network, and/or fulfill whatever other criteria are selected by the service provider as bumping that contact up to the next level. Accordingly, as shown in FIG. 4, the user's virtual object 210 may have acquired an additional accessory. For example, the generic tires shown on the automobile of FIG. 3 may be replaced with fancy tires 212. Any of a variety of other accessories may be used to show that a user has a social network warranting a level two virtual object.

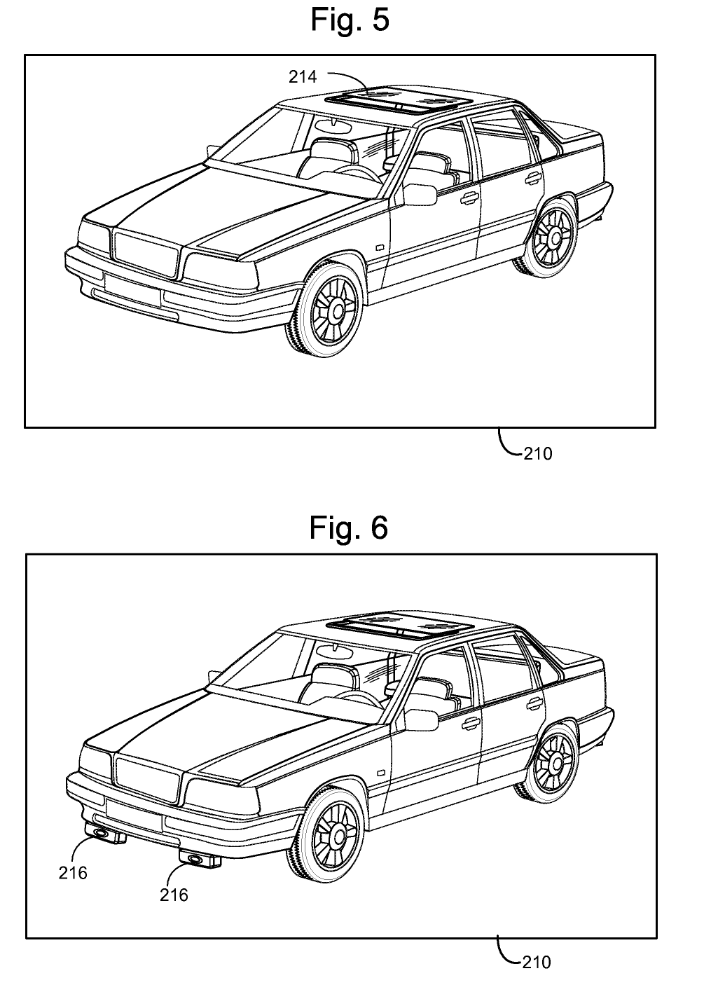

As more time elapses, the strength of the contact's social network may have increased to the point where the user attains level three. Accordingly, as shown in FIG. 5, the user's virtual object 210 may have acquired an additional accessory. For example, in addition to the fancy tires, the automobile may include a sun roof 214. Again, any of a variety of other accessories may be used to show that a user has a social network warranting a level three virtual object.

As still further time elapses, the strength of the contact's social network may have increased to the point where the user attains level four. Accordingly, as shown in FIG. 6, the user's virtual object 210 may have acquired an additional accessory. For example, in addition to the fancy tires and sun roof, the automobile may include fog lights 216. Again, any of a variety of other accessories may be used to show that a user has a social network warranting a level four virtual object. As described above, there may be more or less than four levels in further embodiments.

Any users scrolling through various contacts will see the contacts' virtual object 210 and quickly and easily be able to tell which contacts have the strongest social networks. In embodiments which include different subgroups, with each subgroup having a different virtual object 210, a user scanning through the different subgroups in their contact list will be able to quickly and easily discern the contacts having the strongest social networks within each subgroup.

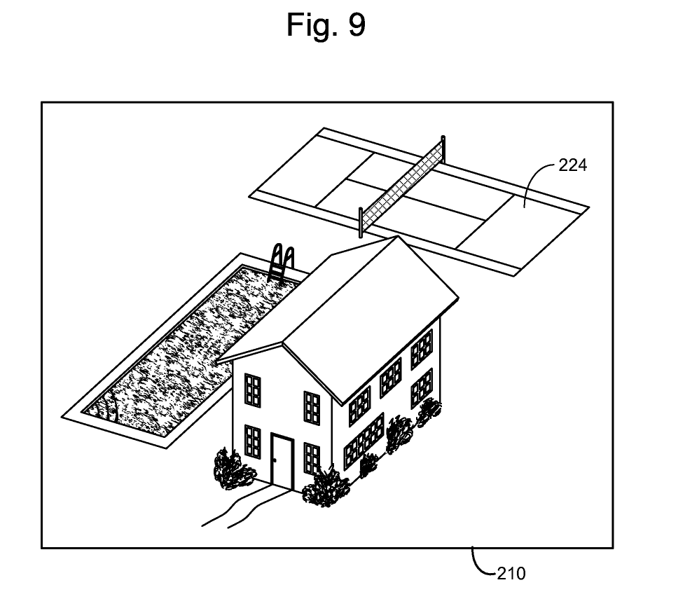

FIGS. 7 through 9 show an alternative virtual object for visually representing the strength and vitality of a contact's social network. In the embodiment of FIG. 7, a contact having a level one social network can have a simple house 220 as the virtual object 210. As shown in the embodiment of FIG. 8, a contact having a level two social network can have a house with a swimming pool 222 as the virtual object 210. As shown in the embodiment of FIG. 9, a contact having a level three social network can have a house with a swimming pool and a tennis court 224 as the virtual object 210. There may be many more than three levels, with each level adding on an accessory or otherwise changing the virtual object 210 in such a way as to allow a user to view the virtual objects of different contacts and quickly and easily ascertain who among them has a stronger or weaker social network.

In the embodiments described above, each higher level includes all of the attributes of the next lower level, plus one or more additional attributes. In the above embodiments, attributes are added upon successive levels by a contact improving the strength of his/her social network under the criteria defined for determining strength of a social network.

In an alternative embodiment, instead of or in addition to attaining new levels by improving social network strength, a user may instead acquire next level accessories, and attain new levels, through trade, purchase or other acquisition of the virtual accessories. Higher level accessories may be available from the service provider or sponsor in exchange for some online currency or for the performance of some other task designated by the service provider or sponsor (which may or may not be related to social networks). For example, it is known for sponsors to provide virtual contacts, or bots, with which users can interact and learn about the sponsor or avail themselves of the sponsors' products or services. In one embodiment, a user may be awarded an accessory for conversing with such a bot and/or for adding the bot to the user's contacts.

The service provider may alternatively or additionally make accessories available for trade or purchase within a social network. Thus, friends can barter for the exchange/acquisition of accessories. Moreover, accessories may be made available to different subgroups so that a user can improve his or her virtual object 210 by contacting others in other subgroups and acquiring the desired accessory. Thus, in this example, instead of or in addition to acquiring accessories by building social networks, the users build social networks by acquiring accessories.

In practice, when a user purchases or otherwise acquires an accessory, the social network virtual object engine 115 may initially authenticate the accessory to determine that it is in fact an authorized accessory. Once authenticated, the accessory may have an identifier which the virtual object engine 115 can associate with a particular stored virtual object. Once the association is identified by the engine 115, the stored graphic including the acquired accessory may be displayed as that user's virtual object. In embodiments, a user may only acquire accessories for the next higher level. Thus, in the embodiment of FIGS. 3-6, a user cannot acquire the level four fog lights until the user has first acquired the level two tires and the level three sun roof on their virtual object. It may be otherwise in alternative embodiments.

Moreover, in a further alternative embodiment, instead of each higher level simply adding to the accessories of the next level below, a higher level may comprise a completely different virtual object. For example, in the embodiment of FIGS. 3-6, instead of adding an accessory (tires, sun roof, fog lights) to indicate next higher levels, the successive levels may be indicated by displaying completely different automobiles. Thus, the first level may be a graphic of an economy car, a second level may be a graphic of a full size car such as an SUV, and the third level may be a graphic of a luxury car such as a Rolls Royce. In such an embodiment, each successive level should have characteristics that readily indicate its being an improvement over the next lower level.

Instead of merely being an indicator of the strength of a social network, the virtual object 210 may itself become a vehicle for building online activity for the service provider. In particular, as more impressive and luxurious virtual objects become a source of pride and bragging rights for users, users may build their social networks at least in part as a means to attain higher levels and improve their virtual object. Where accessories may be acquired through trade and barter, entire online forums may be dedicated to the trade and acquisition of different accessories.

In a further embodiment, a user's virtual object may be extended for use in games and other applications. For example, in an embodiment, a contact's virtual object may be a fighter that goes up in level as the contact's social network gets stronger. In particular, as the contact's social network gets stronger, the appearance of the virtual object changes to show that the fighter gets stronger or otherwise gains ability or experience. That virtual object may then be used as the contact's avatar in a video game where the social network level of the virtual object carries over to the strength/ability level of the contact's avatar in the game. Thus, the stronger the user's social network, the better the user potentially does in the game. That is, just because his or her avatar has strong abilities, he/she may still be bested by another player with weaker abilities due to the skill or luck of the other player.

In a similar vein, where the virtual object is an automobile as described above, the level of the automobile may be applied to an automobile in an auto race video game. Thus, higher level virtual objects will result in cars having more capabilities in the auto racing game than lower level virtual objects.

In embodiments, virtual object 210 may be a graphical object with no embedded links. In further embodiments, the virtual object 210 may additionally include an embedded link making the virtual object 210, in effect, three dimensional. For example, where the virtual object 210 is a house, a user may click on the house, which results in the opening of a new window showing a larger view of the house. The user may then use the graphical pointing device and/or keyboard keys to enter the house and navigate around the house. The user may travel from room to room, upstairs, downstairs, etc.

The navigation around the house, and the presentation of new screens during the navigation around the house, may be accomplished with known technology. However, according to an aspect of the present system, the presentation of the different rooms and areas within the house during the navigation may vary depending on the level of the contact's social network. Thus, different graphics for the rooms and areas of the house may be stored for each different level, so that what a user is shown as he/she navigates through the house is tailored to the specific level of the contact whose house the user is viewing. A house for a contact with a high level social network may have nicer rooms and areas than a house for a contact with a lower level social network. The graphics for each room/area for each level may be stored in the database server 110, and the social network virtual object engine 115 may select the appropriate level graphics data for display during a navigation. It is understood that other virtual objects, such as automobiles, boats, gardens, etc. may be made three dimensional in this manner.

In a further example of the present system, as a contact's social network gets stronger, new capabilities and functionality may be added to their virtual object 210. For example, where the virtual object is a house, they may attain the ability to host a party in the house. Alternatively, they may attain the ability to hand out digital gifts or to play music. Other new capabilities and/or functionalities may be added as a contact's social network gets stronger. Thus, the virtual object 210 may exist in areas outside of the GUI of an actual social contact list. It may exist standalone in another environment (such as in a game) or as one of many other integrated objects (such as in a showcase).

While embodiments described above relate to a virtual object for indicating the strength of a contact's social network, it is understood that the virtual object may indicate other traits associated with a contact's social network in alternative embodiments. For example, where a social network is built around a specific theme, the virtual object may represent the strength or frequency with which a contact partakes of activities relating to that theme. Other examples are contemplated.

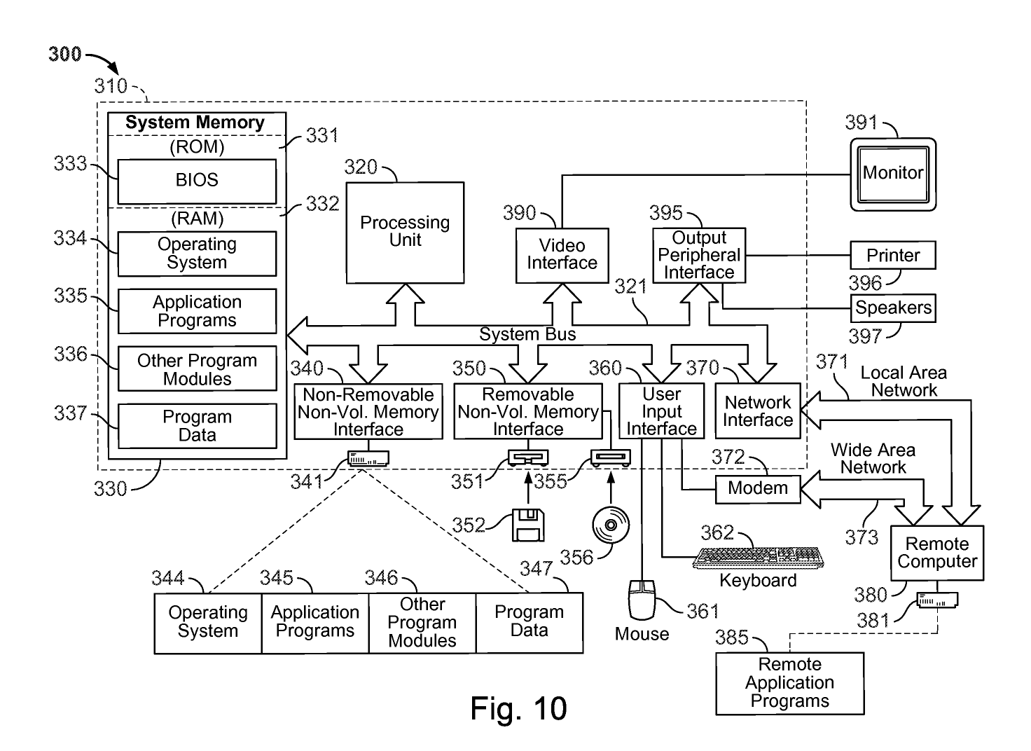

FIG. 10 illustrates an example of a suitable general computing system environment 300 that may comprise any processing device shown herein on which the inventive system may be implemented. The computing system environment 300 is only one example of a suitable computing environment and is not intended to suggest any limitation as to the scope of use or functionality of the inventive system. Neither should the computing system environment 300 be interpreted as having any dependency or requirement relating to any one or combination of components illustrated in the exemplary computing system environment 300.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 10, an exemplary system for implementing the inventive system includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 310 may include a variety of computer readable media. Computer readable media can be any available media that can be accessed by computer 310 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile discs (DVD) or other optical disc storage, magnetic cassettes, magnetic tape, magnetic disc storage or other magnetic storage devices, or any other medium which can be used to store the desired information and which can be accessed by computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 330 includes computer storage media in the form of volatile and/or nonvolatile memory such as ROM 331 and RAM 332. A basic input/output system (BIOS) 333, containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 10 illustrates operating system 334, application programs 335, other program modules 336, and program data 337.

The computer 310 may also include other removable/non-removable, volatile/nonvolatile computer storage media. By way of example only, FIG. 10 illustrates a hard disc drive 341 that reads from or writes to non-removable, nonvolatile magnetic media and a magnetic disc drive 351 that reads from or writes to a removable, nonvolatile magnetic disc 352. Computer 310 may further include an optical media reading device 355 to read and/or write to an optical media 300.

Other removable/non-removable, volatile/nonvolatile computer storage media that can be used in the exemplary operating environment include, but are not limited to, magnetic tape cassettes, flash memory cards, digital versatile discs, digital video tape, solid state RAM, solid state ROM, and the like. The hard disc drive 341 is typically connected to the system bus 321 through a non-removable memory interface such as interface 340, magnetic disc drive 351 and optical media reading device 355 are typically connected to the system bus 321 by a removable memory interface, such as interface 350.

The drives and their associated computer storage media discussed above and illustrated in FIG. 10, provide storage of computer readable instructions, data structures, program modules and other data for the computer 310. In FIG. 10, for example, hard disc drive 341 is illustrated as storing operating system 344, application programs 345, other program modules 346, and program data 347. These components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and a pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 10. The logical connections depicted in FIG. 10 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 10 illustrates remote application programs 385 as residing on memory device 381. It will be appreciated that the network connections shown are exemplary and other means of establishing a communications link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of providing an indication of a strength of a social network of a plurality of contacts, the method comprising the steps of:
(a) measuring the strengths of the respective social networks of the plurality of contacts at least in part based on the number of people in the respective social networks of the plurality of contacts; and
(b) associating a virtual graphical object with each of the plurality of contacts, an appearance of the virtual graphical object associated with each of the plurality of contacts determined at least in part based on the strength of the social network of each contact measured in said step (a).

2. A computer implemented method as recited in claim 1, further comprising the step (c) of associating a first virtual object with a first group of contacts and associating a second virtual object with a second group of contacts, the first group having stronger social networks than the second group, the first virtual object being nicer than the second virtual object.

3. A computer implemented method as recited in claim 2, the first virtual object having the same graphical accessories as the second virtual object, plus some additional graphical accessories.

4. A computer implemented method as recited in claim 2, further comprising the step (d) of moving a contact from the second group to the first group upon the contact's social network becoming stronger under said step (a).

5. A computer implemented method as recited in claim 2, further comprising the step (e) of displaying the first and second virtual objects in association with the contacts in the first and second groups, respectively.

6. A computer implemented method as recited in claim 1, said step (a) of measuring the strengths of the respective social networks of the plurality of contacts further comprising the step of measuring the strengths of the respective social networks of the plurality of contacts based in part on the frequency with which the contacts communicate with others in their social network.

7. A computer implemented method as recited in claim 1, said step (a) of measuring the strengths of the respective social networks of the plurality of contacts comprising the step of a service provider selecting criteria by which the strengths of the respective social networks are measured.

8. A computer implemented method as recited in claim 1, said step (b) of associating a virtual object with each of the plurality of contacts comprising the step of associating one of a graphical image of an automobile, a boat, a house, a building, a person and a garden with the plurality of contacts.

9. A computer implemented method of providing an indication of a strength of a social network of a plurality of contacts, the method comprising the steps of:
(a) selecting one or more measurable criteria for measuring the strength of the social network of the plurality of contacts in the social network;
(b) determining the strengths of the respective social networks for each of the plurality of contacts based on the criteria selected in said step (a); and
(c) displaying virtual objects for the plurality of contacts with an appearance allowing a user to view the virtual objects of the plurality of contacts and to ascertain who among them has a stronger or weaker social network based on the appearance of the respective virtual objects.

10. A computer implemented method as recited in claim 9, said step (a) comprising the step of selecting as measurable criteria one or more of:
(i) the total number of people in a given contact's social network;
(ii) the frequency with which the given contact communicates with others within his/her social network; and
(iii) the number of other people that have the given contact within their respective social networks.

11. A computer implemented method as recited in claim 9, wherein the measurable criteria are selected by a service provider.

12. A computer implemented method as recited in claim 9, said step (c) comprising the step of displaying the contacts having a stronger social network with a nicer virtual object than contacts having a weaker social network.

13. A computer implemented method as recited in claim 12, said step (c) comprising the step of displaying the contacts having a stronger social network with a virtual object having more graphical accessories than contacts having a weaker social network.

14. A computer implemented method as recited in claim 12, said step (c) comprising the step of displaying one of an automobile, a boat or a house, the contacts having a stronger social network being displayed with a nicer automobile, boat or house than contacts having a weaker social network.

15. A computer implemented method as recited in claim 9, further comprising the steps of embedding a link within the virtual object and allowing three dimensional exploration of the virtual object on a graphical user interface upon selection of the embedded link.

16. A computer implemented method as recited in claim 9, further comprising the step of using the strength of a contact's social network at least in part in determining the capability of an avatar or object under the control of the contact in a video game played by the contact.

17. A computer implemented method of providing an indication of a strength of a social network of a plurality of contacts, the method comprising the steps of:
(a) selecting one or more measurable criteria for measuring the strength of the social network of the plurality of contacts in the social network;
(b) determining the strengths of the respective social networks for each of the plurality of contacts based on the criteria selected in said step (a);
(c) categorizing the contacts into different levels based at least in part on a strength of their social network, contacts with higher strengths of their social network being categorized into a higher level than contacts with lower strengths of their social networks;
(d) associating a virtual object having varying numbers of graphical accessories with each of the plurality of contacts, the virtual objects for contacts categorized at higher levels having more graphical accessories than the virtual objects for contacts categorized at lower levels; and
(e) displaying contact information on a graphical user interface together with its associated virtual object.

18. A computer implemented method as recited in claim 17, further comprising the step of a contact moving from a first level to a second higher level upon adding additional people to his/her social network.

19. A computer implemented method as recited in claim 17, further comprising the step of a contact moving from a first level to a second higher level upon acquiring one or more additional accessories of the virtual object in the second higher level through an online trade or purchase.

20. A computer implemented method as recited in claim 17, further comprising the step of a contact moving from a first level to a second higher level upon performing one or more tasks specified by a service provider or sponsor associated with the service provider.
